(19) United States
(12) Patent Application Publication
(10) Pub. No.: US 2026/0080837 A1
(43) Pub. Date: Mar. 19, 2026

(54) Display Device

(71) Applicant: LG Display Co., Ltd., Seoul (KR)

(72) Inventors: Soon Hwan Hong, Paju-si (KR); Chang Soo Kim, Paiu-si (KR)

(21) Appl. No.: 19/279,384

(22) Filed: Jul. 24, 2025

(30) Foreign Application Priority Data
Sep. 13, 2024 (KR) 10-2024-0125588

(51) Int. Cl. G09G 3/3291; G09G 3/3266

(52) U.S. Cl. CPC G09G 3/3291; G09G 3/3266; G09G 2300/043; G09G 2300/0819; G09G 2310/0297; G09G 2310/08; G09G 2320/0209

(57) ABSTRACT

A display device includes a data drive IC configured to output a data voltage through a data channel, data lines arranged in a first direction to transmit the data voltage to subpixels, pixel units configured to share one data line and each including a first color subpixel, a second color subpixel, and a third color subpixel sequentially arranged in the same direction as a direction of the data line, a first multiplexer configured to transmit a data voltage output from a first data channel to a first data line to which a first pixel unit is connected, and a second multiplexer configured to transmit a data voltage output from the first data channel to a second data line to which a second pixel unit is connected.

### CROSS-REFERENCE TO RELATED APPLICATION

This application claims the benefit of Republic of Korea Patent Application No. 10-2024-0125588, filed on Sep. 13, 2024, which is hereby incorporated by reference in its entirety.

### BACKGROUND

### Field of the Disclosure

The present disclosure relates to a display device.

### Discussion of the Related Art

An electroluminescent display device may display an image by including a plurality of subpixels and having a light emitting element in each subpixel emit light. The light emitting element may be implemented based on an organic or inorganic material.

The electroluminescent display device includes a display panel including a plurality of subpixels, a gate driver for supplying a driving signal to the display panel, and a data driver for supplying a data signal, and may display an image by performing a control operation so that the subpixels transmit or emit light.

Such an electroluminescent display device has gradually evolved to have higher resolution so that display performance is improved. In the case of a high-resolution display, the number of subpixels needs to increase, and as the number of subpixels increases, the number of gate lines and data channels increases. Accordingly, the mounting area of the gate driver increases, and the number of data drive ICs (D-ICs) increases, so that there is a problem that design restrictions arise due to insufficient design area.

### SUMMARY

Accordingly, the present disclosure is directed to a display device that substantially obviates one or more problems due to limitations and disadvantages of the related art.

Embodiments disclosed in the present disclosure are intended to solve the above-mentioned problem, and provide a display device capable of reducing the area for mounting a gate driver by reducing the number of gate lines, and reducing the number of data drivers by reducing the number of data channels.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a display device includes a data drive IC configured to output a data voltage through a data channel, data lines arranged in a first direction to transmit the data voltage to subpixels, pixel units configured to share one data line and each including a first color subpixel, a second color subpixel, and a third color subpixel sequentially arranged in the same direction as a direction of the data line, a first multiplexer configured to transmit a data voltage output from a first data channel to a first data line to which a first pixel unit is connected, and a second multiplexer configured to transmit a data voltage output from the first data channel to a second data line to which a second pixel unit is connected.

The display device may further include a gate drive IC configured to output a gate signal, and gate lines arranged in a second direction to transmit the gate signal to the subpixels.

The gate drive IC may include a first gate drive IC arranged at one end of the gate lines and a second gate drive IC arranged at the other end of the gate lines.

The first gate drive IC may output a gate signal to an odd gate line among the gate lines, and the second gate drive IC may output a gate signal to an even gate line among the gate lines.

The first gate drive IC may output a gate signal to subpixels included in the first pixel unit, and the second gate drive IC may output a gate signal to subpixels included in the second pixel unit.

The data drive IC may output a data voltage for writing data to the first color subpixel, the second color subpixel, and the third color subpixel of the first pixel unit, and a data voltage for writing data to the first color subpixel, the second color subpixel, and the third color subpixel of the second pixel unit to the first data channel.

The display device may further include a timing controller configured to output a control signal for controlling the data drive IC and the gate drive IC.

The timing controller may output a first multiplexer signal for turning on and off the first multiplexer and a second multiplexer signal for turning on and off the second multiplexer, and perform a control operation so that the first multiplexer and the second multiplexer are alternately turned on.

Each of the subpixels may include a light emitting element, a driving transistor configured to generate a driving current to be supplied to the light emitting element, a storage capacitor configured to store the data voltage and connected to a gate node of the driving transistor, a first switching transistor configured to store the data voltage in the storage capacitor in response to an Nth scan signal, a second switching transistor configured to connect the driving transistor so that the driving transistor is in a diode-connected state in response to the Nth scan signal, a light emitting transistor configured to connect the driving transistor to the light emitting element in response to an emission signal, a first initialization transistor configured to initialize an anode of the light emitting element to a reference voltage in response to an (N−1)th scan signal, and a second initialization transistor configured to initialize a gate electrode of the driving transistor to the reference voltage in response to the (N−1)th scan signal.

Each of the subpixels may include a light emitting element, a driving transistor configured to generate a driving current to be supplied to the light emitting element, a storage capacitor having a first capacitor electrode connected to a gate node of the driving transistor, a first switching transistor having a first electrode connected to the data line and a second electrode connected to a second capacitor electrode of the storage capacitor in response to an Nth scan signal, a second switching transistor configured to interconnect a gate electrode of the driving transistor and a second electrode of the driving transistor so that the driving transistor is in a diode-connected state in response to the Nth scan signal, a third switching transistor configured to connect a reference voltage to a second capacitor electrode of the storage capacitor in response to an emission signal, a fourth switching transistor configured to connect the driving transistor to the light emitting element in response to the emission signal, a fifth switching transistor configured to connect the reference voltage to an anode of the light emitting element in response to an (N−1)th scan signal, and a sixth switching transistor configured to connect the reference voltage to the gate electrode of the driving transistor in response to the (N−1)th scan signal.

The first gate drive IC sequentially applies an odd scan signal corresponding to an on level for ⅓ of a horizontal period through the odd gate line, and the second gate drive IC sequentially applies an even scan signal corresponding to the on level for ⅓ of the horizontal period through the even gate line.

The display device according to claim 11, wherein the odd scan signal and the even scan signal have overlapping periods of ½ time.

Each of the (N−1)th scan signal, the Nth scan signal and an (N+1)th scan signal is simultaneously supplied to subpixels of two consecutive lines.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a schematic configuration diagram of a display device according to an embodiment of the present disclosure;

FIG. 2 is a diagram illustrating a connection relationship between a data drive IC (D-IC) and data lines included in the display device according to an embodiment of the present disclosure;

FIG. 3 is a circuit diagram of a subpixel of the display device according to an embodiment of the present disclosure;

FIG. 4 is a driving waveform diagram of the subpixel of FIG. 3 according to an embodiment of the present disclosure;

FIG. 5 is a drawing for describing a data signal supply structure of the display device according to an embodiment of the present disclosure;

FIG. 6 is a drawing for describing a gate signal supply structure of a display device according to a first embodiment of the present disclosure;

FIG. 7 is a drawing for describing a gate signal supply structure of a display device according to a second embodiment of the present disclosure;

FIG. 8 and FIG. 9 are drawings for describing a method of driving a subpixel of a display device according to an embodiment of the present disclosure;

FIGS. 10 and 11 are drawings for comparing and describing a data line connection method between a display device having a 2 Mux structure according to a comparative example and a display device having a TRD+2 Mux structure according to an embodiment of the present disclosure; and

FIGS. 12 and 13 are drawings for comparing and describing a pixel driving method between the display device having the 2 Mux structure according to the comparative example and the display device having the TRD+2 Mux structure according to the embodiment of the present disclosure.

### DETAILED DESCRIPTION

Advantages and features of the present disclosure and a method of achieving the advantages and features will become clear with reference to the embodiments described in detail below together with the accompanying drawings. However, the present disclosure is not limited to the embodiments disclosed below and may be implemented in various different forms, and the present embodiments are provided only to make the disclosure of the present disclosure complete and to fully inform a person having ordinary skill in the art to which the present disclosure pertain of the scope of the invention. The present disclosure is defined solely by the scope of the claims.

The shapes, sizes, ratios, angles, numbers, etc. disclosed in the drawings to describe the embodiments of the present disclosure are illustrative, and thus the present disclosure is not limited to the illustrated matters. The same reference numerals refer to the same components throughout the specification. When the terms “include”, “have”, and “comprising”, etc. are used in the present disclosure, other parts may be added unless “only” is used. When a component is expressed in a singular form, this includes the case where the component is plural unless there is a specifically explicit description.

When interpreting a component, the component is interpreted as including an error range even if there is no separate explicit description.

When describing a positional relationship, for example, when a positional relationship between two parts is described as “on”, “above”, “below”, “next to”, etc., one or more other parts may be located between the two parts, unless “immediately” or “directly” is used.

Even though the terms first, second, etc. may be used to describe various components, these components are not limited by these terms. These terms are only used to distinguish one component from another. Thus, a first component mentioned below may be a second component within the technical concept of the present disclosure.

Throughout the specification, the same reference numerals refer to substantially the same components. Hereinafter, embodiments of the present disclosure will be described in detail with reference to the attached drawings. In the following description, when it is determined that a detailed description of a known function or configuration related to the present disclosure may unnecessarily obscure the gist of the present disclosure, the detailed description will be omitted.

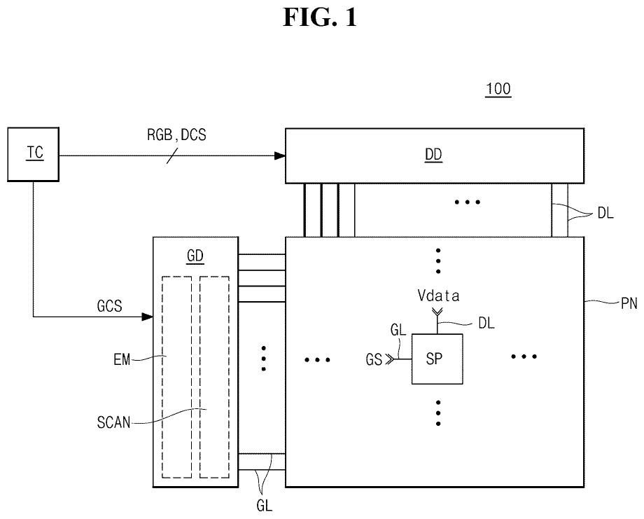

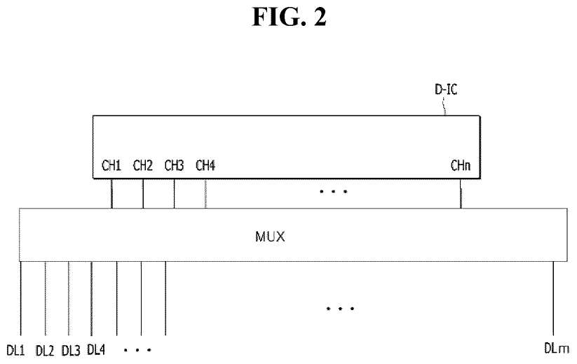

FIG. 1 is a schematic configuration diagram of a display device according to an embodiment of the present disclosure, and FIG. 2 is a diagram illustrating a connection relationship between a data drive IC (D-IC) and data lines included in the display device according to an embodiment of the present disclosure.

In FIG. 1, a display panel PN, a gate driver GD, a data driver DD, and a timing controller TC among various components of a display device 100 are illustrated for convenience of description. Positions of the display panel PN, the gate driver GD, the data driver DD, and the timing controller TC shown in FIG. 1 have been defined for convenience of the drawing and may be changed.

Referring to FIG. 1, the display device 100 includes the display panel PN including a plurality of subpixels SP, the gate driver GD and the data driver DD that supply various signals to the display panel PN, and the timing controller TC that controls the gate driver GD and the data driver DD.

The display panel PN is a configuration for displaying an image to a user and includes a plurality of subpixels SP. In the display panel PN, a plurality of gate lines GL and a plurality of data lines DL intersect each other, and a plurality of subpixels SP are arranged in a matrix form and connected to the gate lines SL and the data lines DL, respectively. Each subpixel SP may be connected to a power wire such as a high-potential wire, a low-potential wire, or a reference wire.

A subpixel SP is the minimum unit that constitutes a screen, and each subpixel SP includes a light emitting element and a subpixel circuit for driving the same. The light emitting elements may be defined differently depending on the type of the display panel PN. For example, when the display panel PN is an inorganic light emitting display panel, the light emitting element may be a light emitting diode (LED) or a micro-LED.

The gate driver GD supplies a plurality of gate signals GS to a plurality of gate lines GL according to a plurality of gate control signals GCS provided from the timing controller TC. The gate driver GD may include a scan driver SCAN and an EM driver EM. In response to the plurality of gate control signals GCS provided from the timing controller TC, the scan driver SCAN may output a scan signal SCAN, and the EM driver EM may output an EM signal EM. The scan signal SCAN and the EM signal EM may be sequentially supplied to a gate line GL. The scan signal SCAN and the EM signal EM can be included in the gate signal. The gate driver GD may be formed as an IC or may be formed directly on the display panel PN in a gate-in-panel (GIP) manner. The gate driver GD formed in the GIP manner may be arranged at one edge of the display panel PN or may be arranged separately at both edges of the display panel 150.

The data driver DD converts image data RGB input from the timing controller TC into a data voltage Vdata using a reference gamma voltage according to a plurality of data control signals DCS provided from the timing controller TC. The data driver DD may supply the converted data voltages Vdata to the plurality of data lines DL. The data driver DD may include at least one data driver IC D-IC. As illustrated in FIG. 2, the data driver IC D-IC may convert the image data RGB into the data voltage Vdata based on the data control signals DCS, and then supply the data voltage Vdata to data lines DL1 to DLm through data output channels CH1 to CHn. A multiplexer MUX for controlling transmission of the data voltage Vdata may be interposed between the output channels CH1 to CHn of the data driver IC D-IC and the data lines DL1 to DLm. The multiplexer MUX includes a plurality of switches and may transmit data voltages Vdata output from the output channels CH1 to CHn to preset data lines DL1 to DLm. Therefore, the data voltage Vdata may be transmitted to a greater number of data lines DL1 to DLm than the number of output channels CH1 to CHn.

The timing controller TC aligns image data RGB input from the outside and supplies the image data RGB to the data driver DD. The timing controller TC may generate a gate control signal GCS and a data control signal DCS using a synchronization signal input from the outside, for example, a dot clock signal, a data enable signal, and a horizontal/vertical synchronization signal.

The timing controller TC may control the gate driver GD and the data driver DD by supplying the generated gate control signal GCS and data control signal DCS to the gate driver GD and the data driver DD, respectively.

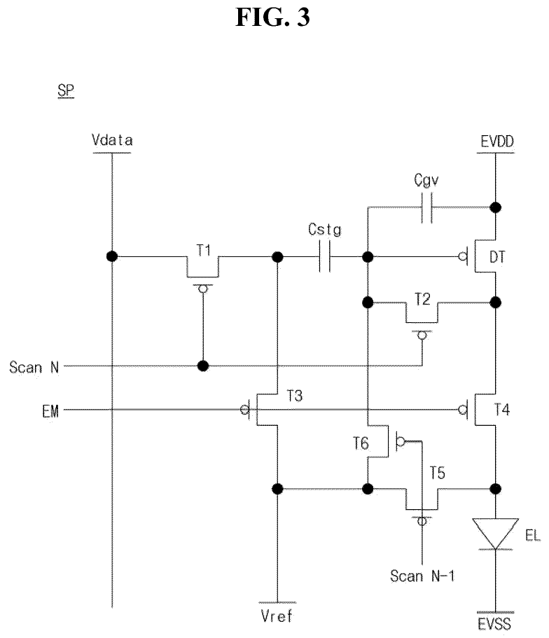

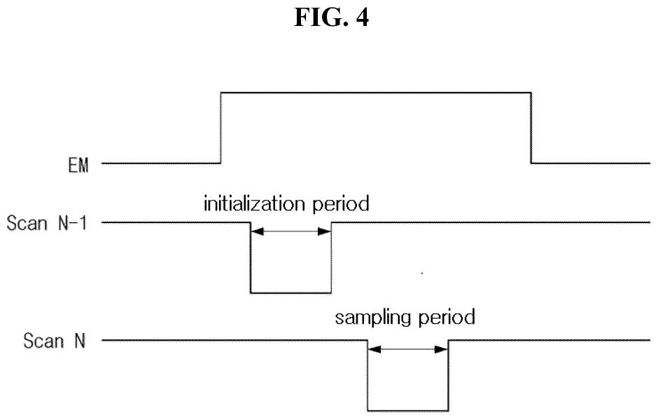

FIG. 3 is a circuit diagram of a subpixel of the display device according to an embodiment of the present disclosure and FIG. 4 is a driving waveform diagram of the subpixel of FIG. 3 according to an embodiment of the present disclosure.

Referring to FIGS. 3 and 4, the subpixel may include six switching transistors T1 to T6, one driving transistor DT, one storage capacitor Cst, and one light emitting diode OLED. Cgv may be a compensation capacitor provided for compensation, which may be omitted.

The first switching transistor T1 may transmit a data voltage Vdata applied through a data line to one end of the storage capacitor Cstg in response to an Nth scan signal Scan N.

The second switching transistor T2 may electrically connect a gate electrode and a second electrode of the driving transistor DT in response to the Nth scan signal Scan N. Accordingly, the driving transistor DT may be in a diode connection state for compensation of a threshold voltage.

The third switching transistor T3 may transmit a reference voltage VREF applied through a reference line to one end of the storage capacitor Cst in response to the emission control signal EM.

The fourth switching transistor T4 may transmit a driving current generated from the driving transistor DT to an anode of the light emitting diode OLED in response to the emission control signal EM.

The third switching transistor T3 and the fourth switching transistor T4 may perform a function of an emission control transistor.

The fifth switching transistor T5 may transmit the reference voltage VREF applied through the reference line to the anode of the light-emitting diode OLED in response to an (N−1)th scan signal Scan N−1.

The sixth switching transistor T6 may transmit the reference voltage VREF applied through the reference line to the gate electrode of the driving transistor DT in response to the (N−1)th scan signal Scan N−1.

The fifth switching transistor T5 and the sixth switching transistor T6 may perform a function of an initialization transistor.

The storage capacitor Cst may store the data voltage Vdata and drive the driving transistor DT based on the stored data voltage. The light emitting diode OLED may perform a function of emitting light based on the driving current generated from the driving transistor DT.

According to this configuration, the subpixel may initialize the gate electrode of the driving transistor DT and the anode of the light emitting diode OLED to the reference voltage VREF based on the fifth and sixth switching transistors T5 and T6, etc. during an initialization period, compensate for the threshold voltage of the driving transistor DT based on the second and third switching transistors T2 and T3, etc. during a sampling period, and then control a light emitting time of the light emitting diode OLED based on the fourth switching transistor T4, etc. during a light emitting period. Here, the subpixel according to the embodiment of the present disclosure may receive input of a scan signal of a previous stage, that is, the (N−1)th scan signal Scan N−1 for sampling and driving the subpixel of an (N−1)th line, during the initialization period of the subpixel of the Nth line, and turn on the fifth and sixth switching transistors T5 and T6. After initialization, during the sampling period, the Nth scan signal Scan N may be input and the data voltage Vdata whose threshold voltage is compensated may be stored in the storage capacitor Cst. The Nth scan signal Scan N may be applied to a subpixel of an (N+1)th line to initialize the subpixel of the (N+1)th line. As described above, the subpixel according to the present disclosure may reduce the number of scan signals for driving the subpixel by receiving input of the (N−1)th scan signal Scan N−1 to control driving of the initialization period of the subpixel. In addition, as the number of scan signals for driving the subpixel is reduced, the number of GIP blocks that output scan signals is reduced, so that a structure of the GIP may be simplified.

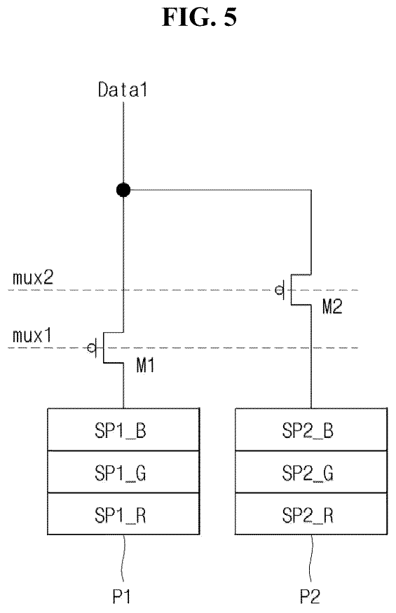

FIG. 5 is a drawing for describing a data signal supply structure of the display device according to an embodiment of the present disclosure, and illustrates a display device having a TRD structure. The display device having the TRD structure may have a structure in which one pixel unit includes three subpixels red R, green G, and blue B, and one pixel unit is driven by one data line.

Referring to FIG. 5, the display device according to the embodiment of the present disclosure may be configured as a TRD+2 Mux structure in which two multiplexers M1 and M2 are connected to one data channel while having the TRD structure. In the display device having the TRD+2 Mux structure, a first pixel unit P1 and a second pixel unit P2 that are horizontally adjacent to each other among a plurality of pixel units arranged on the display panel may share one data channel Data1. The first pixel unit P1 may receive a data voltage applied through a first multiplexer M1 controlled by a mux1 signal, and the second pixel unit P2 may receive a data voltage applied through a second multiplexer M2 controlled by a mux2 signal.

The first pixel unit P1 has a structure in which a blue subpixel SP1_B, a green subpixel SP1_G, and a red subpixel SP1_R are sequentially arranged along a data line.

The second pixel unit P2 has a structure in which a blue subpixel SP2_B, a green subpixel SP2_G, and a red subpixel SP2_R are sequentially arranged along a data line.

In this way, by adopting a configuration in which a data line is shared by sequentially arranging three subpixels included in one pixel unit along the data line, the design area and aperture ratio may be ensured. Meanwhile, a gate line for driving each subpixel may be wired in a direction perpendicular to the data line.

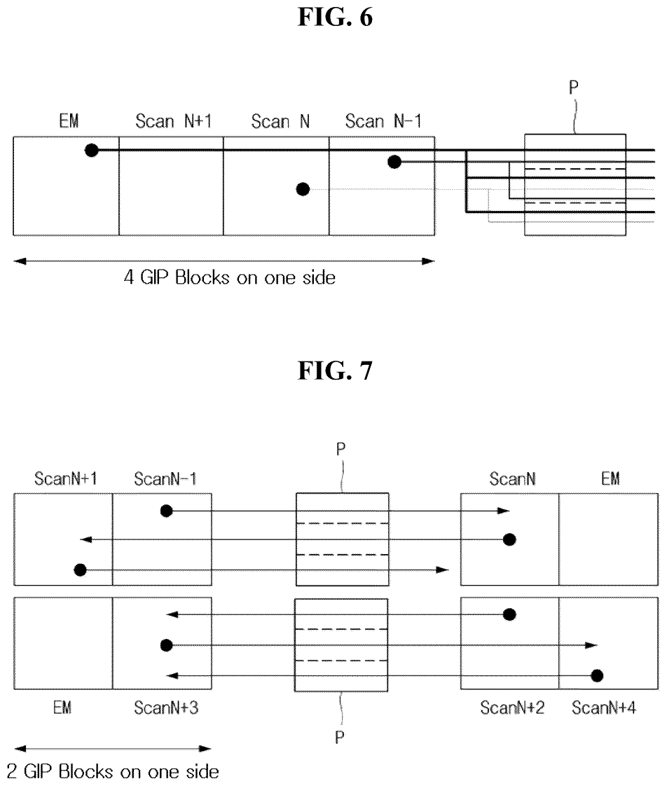

FIG. 6 is a drawing for describing a gate signal supply structure of a display device according to a first embodiment of the present disclosure, and illustrates a case in which a GIP for supplying a gate signal in the display device having the TRD+2 Mux structure is formed only on one side of the display panel.

Referring to FIG. 6, three subpixels may be sequentially arranged along the data line in one pixel unit. As described in the subpixel structure of FIG. 3, in order to drive the subpixel of the Nth line, an (N−1)th scan signal Scan N−1 for initialization, an Nth scan signal Scan N for sampling, and an EM signal for emission are required. One pixel unit includes three subpixels of the (N−1)th line, the Nth line, and the (N+1)th line. Since each subpixel is initialized by receiving the scan signal of the previous line, each of scan signals (Scan N−1, Scan N, and Scan N+1) output from each scan signal block may be simultaneously supplied to subpixels of two lines. Therefore, in the case where a GIP block is provided on one side to drive the pixel unit, four GIP blocks outputting the (N−1)th scan signal Scan N−1, the Nth scan signal Scan N, the (N+1)th scan signal Scan N+1, and the EM signal may be formed to supply the scan signals and the EM signal. By having a structure in which the subpixels receive the scan signal of the previous stage to perform initialization, a GIP block that supplies the scan signal for initialization may be deleted, so that the structure of the GIP may be simplified.

FIG. 7 is a drawing for describing a gate signal supply structure of a display device according to a second embodiment of the present disclosure. The display device according to the second embodiment may be driven in an Even-ODD manner in which GIPs that supply gate signals are formed on both sides of the display panel in the display device having the TRD+2 Mux structure to control an even line Even and an odd line ODD, respectively.

Referring to FIG. 7, when GIP blocks are formed on both sides of the display panel and driven in the Even-ODD manner, in order to drive a pixel unit of a line N and a pixel unit of a line N+1, four GIP blocks for outputting an (N+1)th scan signal Scan N+1, an (N−1)th scan signal Scan N−1, an (N+3)th scan signal Scan N+3, and an EM signal may be formed on one side, and four GIP blocks for outputting an Nth scan signal Scan N, an EM signal, an (N+2)th scan signal Scan N+2, and an (N+4)th scan signal Scan N+4 may be formed on the other side. In this way, when arranging GIP blocks, the width of the GIP blocks arranged on one side may be reduced by half when compared to the display device of the first embodiment of FIG. 6.

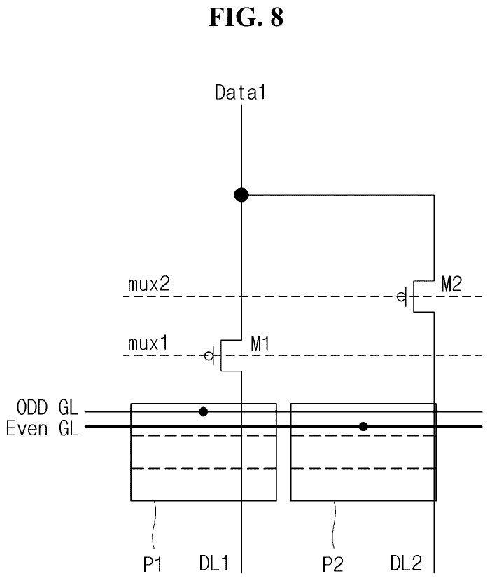

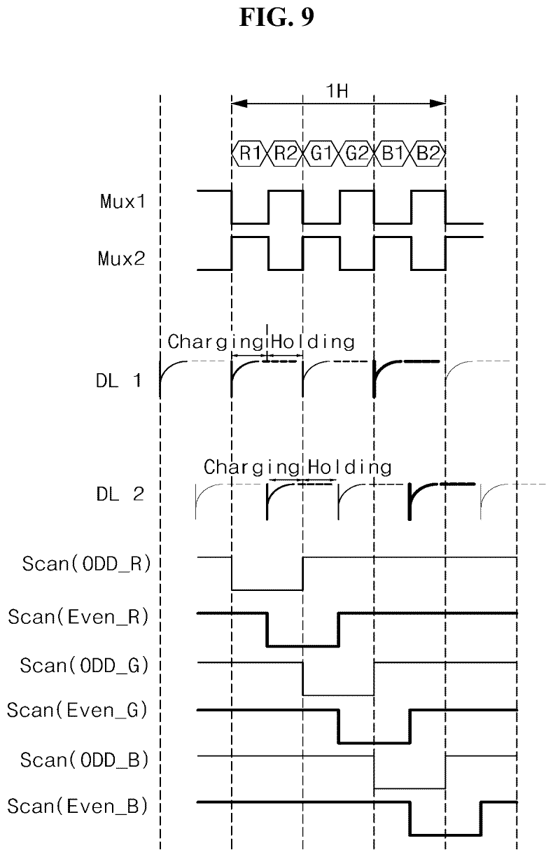

FIG. 8 and FIG. 9 are drawings for describing a method of driving a subpixel of a display device according to an embodiment of the present disclosure, and illustrate a case where the display device having the TRD+2 Mux structure is driven in the Even-ODD manner.

Referring to FIG. 8, when the display device having the TRD+2 Mux structure is driven in the Even-ODD manner, the first pixel unit P1 and the second pixel unit P2 adjacent in a horizontal direction may share one data channel Data1. The first pixel unit P1 is connected to a first data line DL1, and the second pixel unit P2 is connected to a second data line DL2.

The first data line DL1 may receive a data voltage applied through the first multiplexer M1 controlled by the mux1 signal, and the second data line DL2 may receive a data voltage applied through the second multiplexer M2 controlled by the mux2 signal. The first multiplexer M1 and the second multiplexer M2 may be implemented as P-type thin film transistors, respectively. Accordingly, when the mux1 signal and the mux2 signal are applied at a low level, the corresponding multiplexer may be turned on.

The first pixel unit P1 has a structure in which the blue subpixel SP1_B, the green subpixel SP1_G, and the red subpixel SP1_R are sequentially arranged along a data line. The second pixel unit P2 has a structure in which the blue subpixel SP2_B, the green subpixel SP2_G, and the red subpixel SP2_R are sequentially arranged along a data line. The first pixel unit P1 may be connected to an ODD gate line ODD GL, and the second pixel unit P2 may be connected to an even gate line Even GL.

FIG. 9 is a driving waveform diagram for driving the pixel units P1 and P2 of FIG. 8 according to an embodiment of the present disclosure.

Referring to FIGS. 8 and 9, during one horizontal period 1H, a data voltage for charging the first pixel unit P1 and the second pixel unit P2 is output from a data channel Data 1. Data voltages of red R1 and R2, green G1 and G2, and blue B1 and B2 applied to each of the first pixel unit P1 and the second pixel unit P2 may be output from the data channel Data 1.

The mux1 signal and the mux2 signal are alternately output as a low level which is an on level. The mux1 signal and the mux2 signal may be applied as a toggle signal with a cycle of ⅓ H. Therefore, the signals may be applied as an on level for ⅙ H and as an off level for ⅙ H.

The first data line DL1 and the second data line DL2 are charged with a data voltage when the first multiplexer M1 and the second multiplexer M2 are turned on. When the mux1 signal at a low level is input, the first multiplexer M1 is turned on to charge the first data line DL1 with a data voltage, and then, when the mux1 signal at a high level is input, the first multiplexer M1 is turned off to hold the data voltage input to the first data line DL1. When the mux2 signal at a low level is input, the second multiplexer M2 is turned on to charge the second data line DL2 with a data voltage, and then, when the mux2 signal at a high level is input, the second multiplexer M2 is turned off to hold the data voltage input to the second data line DL2.

The scan signal is input to each of the ODD gate line ODD GL and the even gate line Even GL to select a subpixel to which the data voltage is applied. Scan signals Scan (ODD_R), Scan (ODD_G), and Scan (ODD_B) input to the ODD gate line ODD GL may be each sequentially applied at a low level, which is an on level, for a period of ⅓ H, thereby selecting the red subpixel SP1_R, the green subpixel SP1_G, and the blue subpixel SP1_B of the first pixel unit P1. Scan signals Scan(Even_R), Scan(Even_G), and Scan(Even_B) input to the even gate line Even GL may be each sequentially applied at a low level, which is an on level, for a ⅓ H period to select the red subpixel SP2_R, the green subpixel SP2_G, and the blue subpixel SP2_B of the second pixel unit P2. An ODD scan signal starts to be applied at an on level at an on time of the first multiplexer M1 that applies a data voltage to the first pixel unit P1 and is maintained for a ⅓ H period, and the even scan signal starts to be applied at an on level at an on time of the second multiplexer M2 that applies a data voltage to the second pixel unit P2 and may be maintained at an on level for a ⅓ H period. The odd scan signal and the even scan signal may have overlapping periods of ½ time. In this way, since the scan signal is completely separated into Even and ODD, a scan on time (SOT) may be maintained during a charging and holding time of the data line by turning on/off the multiplexers M1 and M2. In other words, since each subpixel may maintain an SOT for ⅓ H, crosstalk due to SOT degradation may be improved.

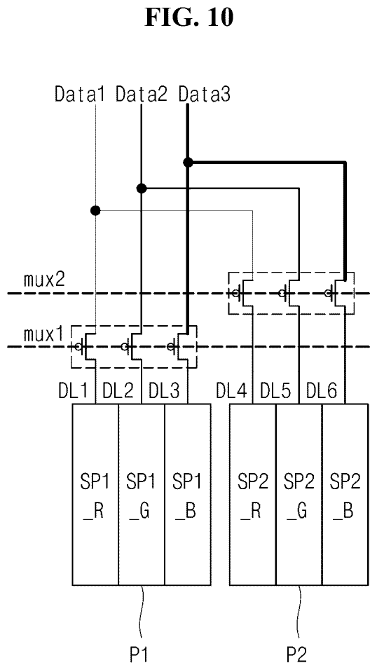

FIGS. 10 to 13 are drawings for comparing and describing a display device having a 2 Mux structure according to a comparative example and a display device having a TRD+2 Mux structure according to an embodiment of the present disclosure. The display device having the 2 Mux structure may selectively apply a data voltage output from one data channel to two data lines by using two Muxes. The display device having the TRD structure may perform time-division driving by sharing one data line among three subpixels.

FIG. 10 is a drawing for describing a data line connection method of the display device having the 2 Mux structure according to the comparative example.

Referring to FIG. 10, the display device having the 2 Mux structure according to the comparative example may selectively supply a data voltage output from one data channel to adjacent subpixels of the same color. That is, a red R data voltage output from a Data1 channel may be supplied to the red subpixel SP1_R of the first pixel unit P1 when the mux1 signal is applied, and may be supplied to the red subpixel SP2_R of the second pixel unit P2 when the mux2 signal is applied. A green G data voltage output from a Data2 channel may be supplied to the green subpixel SP1_G of the first pixel unit P1 when the mux1 signal is applied, and may be supplied to the green subpixel SP2_G of the second pixel unit P2 when the mux2 signal is applied. A blue B data voltage output from a Data3 channel may be supplied to the blue subpixel SP1_B of the first pixel unit P1 when the mux1 signal is applied, and may be supplied to the blue subpixel SP2_B of the second pixel unit P2 when the mux2 signal is applied. The display device of the 2 Mux structure according to the comparative example requires three data channels Data1, Data2, and Data3 and six data lines DL1 to DL6 to supply data to the two pixel units P1 and P2.

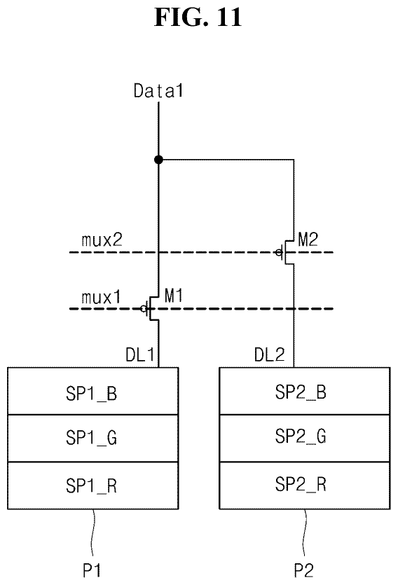

FIG. 11 is a drawing for describing a data line connection method of the display device of the TRD+2 Mux structure according to the embodiment of the present disclosure. In the display device of the TRD+2 Mux structure, one data channel may apply a data voltage to two data lines, and one data line may be shared by three subpixels.

Referring to FIG. 11, the display device according to the embodiment of the present disclosure may have three subpixels red R, green G, and blue B share one data line by the TRD structure. Accordingly, each pixel unit may be connected to one data line. In addition, the 2 Mux structure is applied so that a data voltage output from one data channel may be selectively applied to two data lines. Accordingly, the first pixel unit P1 and the second pixel unit P2 may share one data channel Data1.

In the Data1 channel, three-color (red R, green G, and blue B) data voltages to be supplied to each of the first pixel unit P1 and the second pixel unit P2 may be output. The three-color (red R, green G, and blue B) data voltages output from the Data1 channel may be controlled by the first multiplexer M1 and the second multiplexer M2 and supplied to the corresponding pixel units. The red R data voltage output from the Data1 channel may be supplied to the red subpixel SP1_R of the first pixel unit P1 when the mux1 signal is applied, and may be supplied to the red subpixel SP2_R of the second pixel unit P2 when the mux2 signal is applied. The green G data voltage output from the Data1 channel may be supplied to the green subpixel SP1_G of the first pixel unit P1 when the mux1 signal is applied, and may be supplied to the green subpixel SP2_G of the second pixel unit P2 when the mux2 signal is applied. The blue B data voltage output from the Data1 channel may be supplied to the blue subpixel SP1_B of the first pixel unit P1 when the mux1 signal is applied, and may be supplied to the blue subpixel SP2_B of the second pixel unit P2 when the mux2 signal is applied. The display device having the TRD+2 Mux structure according to this embodiment requires one data channel Data1 and two data lines DL1 and DL2 to supply data to the two pixel units P1 and P2.

When comparing the display device having the 2 Mux structure according to the comparative example of FIG. 10 with the display device having the TRD+2 Mux structure according to the embodiment of the present disclosure of FIG. 11, it can be seen that while the comparative example requires three data channels Data1, Data2, and Data3 and six data lines DL1 to DL6 to supply data to two pixel units P1 and P2, the embodiment requires one data channel Data1 and two data lines DL1 and DL2. Therefore, when the display device having the TRD+2 Mux structure according to the embodiment of the present disclosure is applied, the number of data channels and data lines may be reduced by ⅔. As the number of data channels is reduced by ⅔, the number of D-ICs may also be reduced. In addition, as the number of data lines is reduced by ⅔, data coupling strength between the data lines may also be reduced by ⅔. Accordingly, crosstalk or screen distortion phenomena that can occur due to data coupling may be significantly reduced.

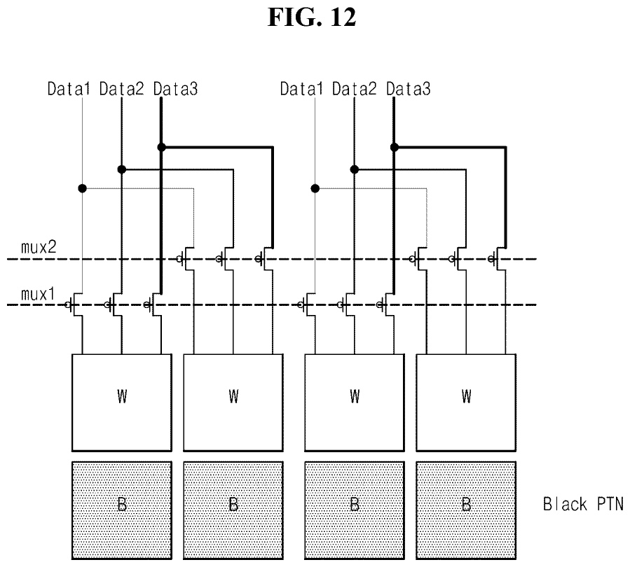

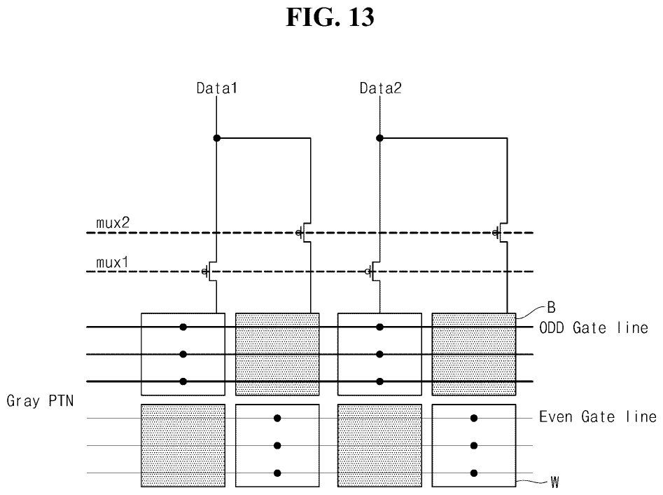

FIG. 12 and FIG. 13 are drawings for comparing and describing a pixel driving method between the display device having the 2 Mux structure according to the comparative example and the display device having the TRD+2 Mux structure according to the embodiment of the present disclosure. FIG. 12 illustrates the comparative example, and FIG. 13 illustrates the embodiment.

Referring to FIG. 12, in the display device having the 2 Mux structure according to a comparative example, subpixels located on the same horizontal line share a gate signal. Therefore, since the subpixels sequentially emit light W in units of one horizontal line, crosstalk may occur in which a black line is recognized in the horizontal direction.

FIG. 13 illustrates a state in which the display device having the TRD+2 Mux structure according to the embodiment of the present disclosure is driven in the Even-ODD manner. By using Even-ODD scan driving, an emission order of two neighboring pixel units sharing a channel may be controlled. Accordingly, as shown in FIG. 13, by performing a control operation so that pixels are driven in zigzag for each line, coupling strength between data lines may be cut in half and reduced. In addition, since pixels W that emit light for each horizontal line are arranged in a zigzag so that all horizontal lines have a gray pattern Gray PTN, crosstalk in which a black line is recognized in the horizontal direction may be eliminated.

As described above, the display device according to the embodiment of the present disclosure may reduce the number of gate lines for inputting scan signals and reduce the mounting area of the gate driver by configuring the subpixels so that each subpixel may receive the scan signal of the previous stage and perform initialization driving. In addition, by applying the TRD (Triple Rate Driving) structure so that one data line is shared by three subpixels and controlling one data channel using two multiplexers Mux, the number of data channels may be reduced and the number of data drive ICs D-ICs may be reduced. In this way, by applying the TRD+2 Mux structure and forming gate drivers on both sides of the panel to perform driving using an EVEN-ODD scan signal, screen defects due to parasitic capacitance of the data line may be minimized.

The embodiments of the present disclosure have the following effects.

The display device according to the embodiments of the present disclosure reduce the number of gate lines for inputting scan signals and reduce the mounting area of the gate driver by configuring the subpixels so that each subpixel may receive the scan signal of the previous stage and perform initialization driving.

The display device according to the embodiments of the present disclosure reduces the number of data channels and the number of data drive ICs D-ICs by applying the TRD structure so that three subpixels share one data line and controlling one data channel using two multiplexers Mux.

The display device according to the embodiments of the present disclosure minimize screen defects due to parasitic capacitance of the data line by applying the TRD+2 Mux structure and forming gate drivers on both sides of the panel to perform driving using the EVEN-ODD scan signal.

The effects of the present disclosure are not limited to those illustrated above, and the present disclosure encompasses a wider variety of effects.

Even though the embodiments of the present disclosure have been described in more detail with reference to the attached drawings, the present disclosure is not necessarily limited to these embodiments, and various modifications may be made without departing from the technical spirit of the present disclosure. Accordingly, the embodiments disclosed in the present disclosure are not intended to limit the technical spirit of the present disclosure but to describe the technical spirit, and the scope of the technical spirit of the present disclosure is not limited by these embodiments. Therefore, it should be understood that the embodiments described above are illustrative and not restrictive in all respects. The scope of protection of the present disclosure should be interpreted by the claims, and all technical ideas within a scope equivalent thereto should be interpreted as being included in the scope of rights of the present disclosure.

What is claimed IS:

1. A display device comprising:
a data drive integrated circuit (IC) configured to output a data voltage through a data channel;
data lines arranged in a first direction, the data lines transmitting the data voltage to subpixels;
pixel units configured to share one data line from the data lines, each pixel unit comprising a first color subpixel, a second color subpixel, and a third color subpixel that are sequentially arranged in a same direction as a direction of the one data line;
a first multiplexer configured to transmit a data voltage output from a first data channel to a first data line from the data lines to which a first pixel unit is connected; and
a second multiplexer configured to transmit a data voltage output from the first data channel to a second data line from the data lines to which a second pixel unit is connected.

2. The display device according to claim 1, further comprising:
a gate drive IC configured to output a gate signal; and
gate lines arranged in a second direction, the gate lines transmitting the gate signal to the subpixels.

3. The display device according to claim 2, wherein the gate drive IC comprises a first gate drive IC arranged at one end of the gate lines and a second gate drive IC arranged at another end of the gate lines.

4. The display device according to claim 3, wherein the first gate drive IC outputs a gate signal to an odd gate line among the gate lines and the second gate drive IC outputs a gate signal to an even gate line among the gate lines.

5. The display device according to claim 3, wherein the first gate drive IC outputs a gate signal to subpixels included in the first pixel unit and the second gate drive IC outputs a gate signal to subpixels included in the second pixel unit.

6. The display device according to claim 1, wherein the data drive IC outputs a data voltage corresponding to writing data to the first color subpixel, the second color subpixel, and the third color subpixel of the first pixel unit, and a data voltage corresponding to writing data to the first color subpixel, the second color subpixel, and the third color subpixel of the second pixel unit to the first data channel.

7. The display device according to claim 2, further comprising:
a timing controller configured to output a control signal that controls the data drive IC and the gate drive IC.

8. The display device according to claim 7, wherein the timing controller outputs a first multiplexer signal that turns on and off the first multiplexer and a second multiplexer signal that turns on and off the second multiplexer, and performs a control operation such that the first multiplexer and the second multiplexer are alternately turned on.

9. The display device according to claim 1, wherein each of the subpixels comprises:
a light emitting element;
a driving transistor configured to generate a driving current that is supplied to the light emitting element;
a storage capacitor configured to store the data voltage, the storage capacitor connected to a gate node of the driving transistor;
a first switching transistor configured to store the data voltage in the storage capacitor in response to an Nth scan signal;
a second switching transistor configured to connect the driving transistor such that the driving transistor is in a diode-connected state in response to the Nth scan signal;
a light emitting transistor configured to connect the driving transistor to the light emitting element in response to an emission signal;
a first initialization transistor configured to initialize an anode of the light emitting element to a reference voltage in response to an (N−1)th scan signal; and
a second initialization transistor configured to initialize a gate electrode of the driving transistor to the reference voltage in response to the (N−1)th scan signal.

10. The display device according to claim 1, wherein each of the subpixels comprises:
a light emitting element;
a driving transistor configured to generate a driving current that is supplied to the light emitting element;
a storage capacitor having a first capacitor electrode connected to a gate node of the driving transistor;
a first switching transistor having a first electrode connected to a data line from the data lines and a second electrode connected to a second capacitor electrode of the storage capacitor in response to an Nth scan signal;
a second switching transistor configured to interconnect a gate electrode of the driving transistor and a second electrode of the driving transistor such that the driving transistor is in a diode-connected state in response to the Nth scan signal;
a third switching transistor configured to connect a reference voltage to the second capacitor electrode of the storage capacitor in response to an emission signal;
a fourth switching transistor configured to connect the driving transistor to the light emitting element in response to the emission signal;
a fifth switching transistor configured to connect the reference voltage to an anode of the light emitting element in response to an (N−1)th scan signal; and
a sixth switching transistor configured to connect the reference voltage to the gate electrode of the driving transistor in response to the (N−1)th scan signal.

11. The display device according to claim 4, wherein the first gate drive IC sequentially applies an odd scan signal corresponding to an on level for ⅓ of a horizontal period through the odd gate line, and the second gate drive IC sequentially applies an even scan signal corresponding to the on level for ⅓ of the horizontal period through the even gate line.

12. The display device according to claim 11, wherein the odd scan signal and the even scan signal have overlapping periods of ½ time.

13. The display device according to claim 9, wherein each of the (N−1)th scan signal, the Nth scan signal and an (N+1)th scan signal is simultaneously supplied to subpixels of two consecutive lines.
